(19) United States
(12) Patent Application Publication
(10) Pub. No.: US 2013/0170785 A1
(43) Pub. Date: Jul. 4, 2013

(54) MULTIFUNCTIONAL INTEGRATED OPTICAL DEVICE

(71) Applicant: Peiliang Gao, Tianjin (CN)

(72) Inventor: Peiliang Gao, Tianjin (CN)

(21) Appl. No.: 13/643,079

(22) PCT Filed: Mar. 12, 2010
(86) PCT No.: PCT/CN10/71006

§ 371 Date: Oct. 23, 2012

(30) Foreign Application Priority Data
Jan. 28, 2010 (CN) 201010300865.1

(51) Int. Cl. G02F 1/035

(52) U.S. Cl. CPC G02F 1/035
USPC 385/8

(57) ABSTRACT

A multifunctional integrated optical device includes an input collimator (101) with a pigtail, an input birefringent crystal wedge (110), a Faraday rotator (120), a Pockels cell (130), an output birefringent crystal wedge (140) and an output collimator (102) with a pigtail, arranged along an optical path in turn. The optical device also includes an electric driver (150) for a variable attenuator and an optical switch, and another electric driver (160) for a modulator. The device employs the Pockels cell for dynamically rotating the polarization state of incident light at nanosecond speed for attenuation and modulation. The device can be used as a polarization independent optical isolator, an optical switch, a variable attenuator and a modulator, without mechanical moving parts, for use in various laser systems and particularly in a fiber optic telecommunication system.

### CROSS-REFERENCE TO RELATED APPLICATIONS

This application is a National Stage Appl. filed under 35 USC 371 of International Patent Application No. PCT/CN2010/071006 with an international filing date of Mar. 12, 2010, designating the United States, and further claims priority benefits to Chinese Patent Application No. 201010300865.1 filed Jan. 28, 2010. Inquiries from the public to applicants or assignees concerning this document or the related applications should be directed to: Matthias Scholl P. C., Attn.: Dr. Matthias Scholl Esq., 14781 Memorial Drive, Suite 1319, Houston, Tex. 77079.

### BACKGROUND OF THE INVENTION

1. Field of the Invention

The invention relates to the optical fiber in-line polarization independent optical isolator, switch, variable optical attenuator, and modulator, and more particularly to such devices which use birefringent crystal wedges, Pockels cell, and Faraday rotator.

2. Description of the Related Art

In-line polarization independent optical isolator, switch, variable attenuator, and modulator are widely used in some fiber laser systems and particularly in the modern fiber optical telecommunication networks.

An optical isolator eliminates unwanted or reflected optical signals from interfering with a desired optical function. In fiber optic communications systems, some lights may be reflected back from the fiber network. This back reflection affects the operation of the laser diode by interfering with and altering the frequency of the laser output oscillations. For this reason, an optical isolator is typically provided between the laser diode and the coupling optical fiber to minimize the back reflection from the fiber network. In free space optical systems, the polarization dependent isolator is often used mainly due to the high degree of linearly polarized light output from laser sources. In fiber optical telecommunication system, the polarization state of the optical signals is usually divergent, and therefore, it is important for such system to install the polarization independent optical devices in order for the system to work effectively.

As disclosed in the prior art, FIG. 1 shows a free space, conventional polarization independent isolator 100. The isolator 100 includes a first birefringent crystal wedge 16 (the polarization plane of the ordinary light and extraordinary light are in vertical and horizontal direction respectively), a second birefringent crystal wedge 24 (the polarization plane of the ordinary light and extraordinary light are at 45 degrees and −45 degrees respectively relative to the first birefringent crystal wedge), and a Faraday rotator 18 disposed between wedge 16 and 24. The angle θ of the wedge 16 and 24 is usually cut at 7 degrees as shown in FIG. 1.

The forward propagating light 10 enters the first birefringent crystal wedge 16 and is split into two linearly polarized lights in vertical (zero degree to x-axis) direction 12, which is called an ordinary light (o-light) and linearly polarized light in horizontal 14 (90 degree to x-axis), which is called an extraordinary light (e-light) as shown in FIG. 2. The Faraday rotator 18 is in x-y plane, and rotates both o-light and e-light by 45 degrees. This means that light 20 and light 22 are at 45 degrees and −45 degrees angle relative to the x-axis as shown in FIG. 3. The second birefringent crystal wedge 24 then combines the light 20 and 22 into one light 26.

FIG. 4 shows the optical path of the backward propagating lights. Light 30 is split by wedge 24 into o-light 32 and e-light 34, which are at 45 degrees and −45 degrees angle relative to the x-axis as shown in FIG. 5. The Faraday rotator 18 then rotates the polarization plane of o-light 32 and e-light 34 by 45 degrees, and o-light 36 and e-light 37 becomes 90 degree and zero degree relative to the x-axis respectively as shown in FIG. 6. Due to the special property of the Faraday rotator in rotating the linearly polarized light, the rotation angle for the backward propagating lights is opposite relative to direction of the forward propagating lights, the light 36 and 37 does not combine into one light, and in instead, continue to divergent into light 38 an 39 respectively after passing through the birefringent crystal wedge 16. For an in-line isolator, it is necessary to install two collimators with pigtailed optical fiber as input port and output port. For the forward propagating light, the light coming out of the input port collimator is split into two linearly polarized lights and then combined into one light coupled into the output collimator. For the backward propagating light, the light is split into linearly polarized lights and then continues to be divergent and therefore, cannot be coupled into the input collimator.

An optical attenuator is one of the important elements of an optical circuit for an optical communication to control an optical signal transmission. In fiber optic communication systems, variable optical attenuators are broadly employed to regulate the optical power levels to prevent damages to the optical receivers caused by irregular optical power variations. As the optical power fluctuates, a variable optical attenuator is employed, in combination with an output power detector and a feedback control loop, to adjust the attenuation and to maintain the optical power inputted to a photo-receiver at a relatively constant level. Optical signal attenuation can be accomplished in a variety of ways through diverting all or a portion of an optical signal from an original pathway.

Variable optical attenuators (VOA) have been developed with a variety of technologies. Currently, there are several types of commercially available variable optical attenuators in the market, i.e., opto-mechanical VOA devices using stepping motor or a magneto-optical crystal, electro-optic VOA devices using liquid crystal (LC) technology, and MEMS VOA devices using micro-electro-mechanical systems (MEMS) technology.

Pockels cells based on Electro-optical crystals birefringence is mostly used as optical shutter or switch in non-telecommunication application mainly due to its very high electric voltage requirement. Pockels electro-optic effect produces birefringence in an optical medium induced by a constant or varying electric field. The electric field can be applied to the crystal medium either longitudinally or transversely to the light beam. Longitudinal Pockels cells need transparent or ring electrodes. Transverse voltage requirements can be reduced by lengthening the crystal. A Pockels cell combined with two polarizers can be used for a variety of applications. FIG. 7 shows a simple configuration of a Pockels cell based device having multiple functions as optical variable attenuator, and modulator as disclosed in some prior arts. FIGS. 8 and 9 show the polarization plane orientation for a normally closed shutter (the shutter is closed without applied voltage) of two polarizer with the polarization plane 41 of first polarizer 44-1 aligned on x-axis, and the polarization plane 45 of second polarizer 44-2 aligned on y-axis.

With the varying electric field generated by Pockels cell driver 49 between zero and half wave voltage, i.e., the voltage under which the plane of polarization of incident light is rotated by 90 degrees by Pockels cell 46, the input light 40-1 can be attenuated from a completely switch-off to total transparent when light 40-2 exits from polarizer 44-2.

Such a configuration is not often used in fiber optical telecommunication system mainly due to its extremely high voltage (half wave voltage is about a few thousands volts or even higher) requirements albeit its ultra fast (nanosecond) response time. With the development of the new materials, the voltage required to create birefringence has been substantially reduced, and therefore the present invention can become a viable approach to be used in fiber optical telecom networks, especially in the optical transmitters with capability of directly modulating the signal from laser emitter at very high frequencies and low voltage.

### SUMMARY OF THE INVENTION

In view of the above-described problems, it is one objective of the invention to provide an integrated, compact and multi functional optical device as polarization independent in-line optical isolator, switch, variable attenuator, and optical modulator without moving parts for applications in variety of laser systems and in particular in fiber optic telecommunication networks.

To achieve the above objective, in accordance with one embodiment of the invention, there is provided an integrated multifunctional optical device, comprising:
an input port collimator with a pigtailed single mode optical fiber and an output port collimator with a pigtailed single mode optical fiber, the input port collimator receiving input lights, the output port collimator providing output lights;
a first birefrigent crystal wedge and a second birefrigent crystal wedge; the first birefrigent crystal wedge receiving the input lights from the input port collimator and splitting into two linearly polarized lights with ordinary lights in a vertical direction and extraordinary lights in a horizontal direction, the second birefrigent crystal wedge with optical axes aligned at 45 degree angle relative to the ordinary lights, and at −45 degree angle relative to the extraordinary lights;
a Pockels cell rotating a polarization plane of the input lights by an external electric voltage, two optical axes of the Pockels cell being aligned with two optical axes of the first birefrigent crystal wedge;
a Faraday rotator disposed between the first birefrigent crystal wedge and the Pockels cell, receiving lights from the first birefrigent crystal wedge; the Pockels cell disposed between the Faraday rotator and the second birefrigent crystal wedge, receiving the lights from the Faraday rotator, the second birefrigent crystal wage disposed between the Pockels cell and the output port collimator, receiving two linearly polarized lights from the Pockels cell, combining the linearly polarized lights into one light and outputting to the output collimator;
at least one electric driver for a variable optical attenuator and an optical switch; and
an electric driver for an optical modulator.

In a class of this embodiment, the input lights to the input port collimator are coherent, monochromatic or the lights with limited optical spectral bandwidth.

In a class of this embodiment, the Faraday rotator is set to rotate the polarization plane of the linearly polarized lights by 45 degree angle for a single wavelength or for lights with limited spectral bandwidth.

In a class of this embodiment, the Faraday rotator is selected based on the wavelength of the input lights.

In a class of this embodiment, the electric field applied to the Pockels cell is parallel or perpendicular to a propagation direction of the input lights.

In a class of this embodiment, the Pockels cell is selected based on the wavelength of the input lights.

In a class of this embodiment, antireflection dielectric thin film coatings are applied to optical path surfaces of the input port collimator, the first birefrigent crystal wage, the Faraday rotator, the Pockels cell, the second birefrigent crystal wage, the output port collimator to reduce the reflection and optical insertion loss.

In a class of this embodiment, the first birefrigent crystal wage, the Faraday rotator, the Pockels cell, and the second birefrigent crystal wage is glued together by an epoxy which is transparent to the input lights, or glued together with an optical path epoxy free method.

Advantages of the invention are summarized below:

The invention provides an integrated and compact multifunctional device as polarization independent and in-line optical isolator, optical switch, optical variable attenuator and modulator without moving parts, which is suitable for use in varies laser systems and particularly in fiber optical telecommunication systems; The disclosed multifunctional device can be used as ultra-fast(nanosecond) optical attenuator and switch; it is easy to manufacture at low cost for high volume production due to the simple and integrated design leading to the high reliability and manufacturability.

### BRIEF DESCRIPTION OF THE DRAWINGS

FIG. 1 shows an optical isolator design disclosed in the prior art;

FIG. 2 illustrates a polarization plane orientation of two lights after passing through a first birefringent crystal wedge of the isolator shown in FIG. 1;

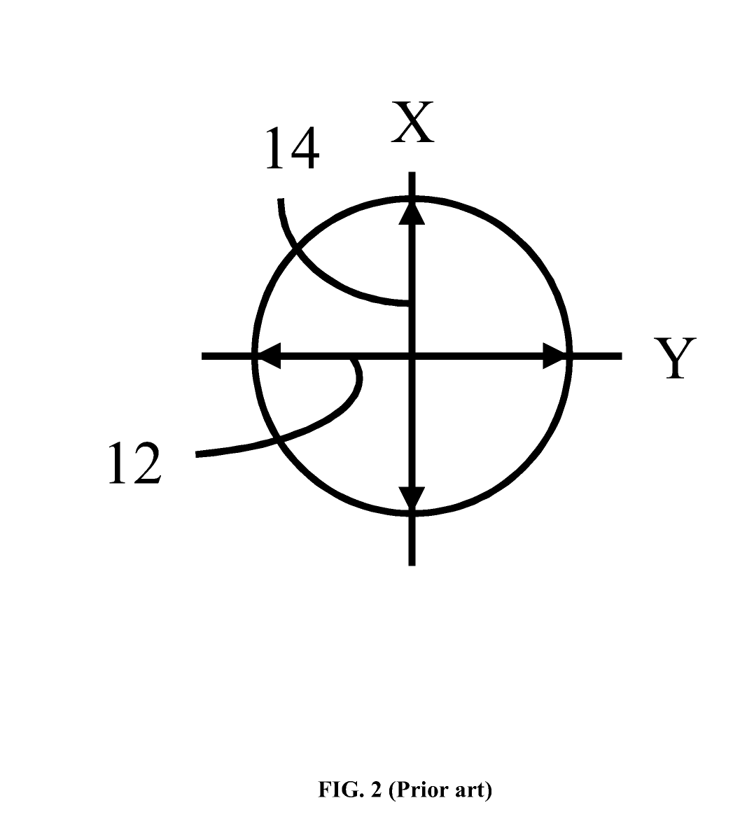

FIG. 3 illustrates a polarization plane orientation of two lights after passing through a Faraday rotator of the isolator shown in FIG. 1;

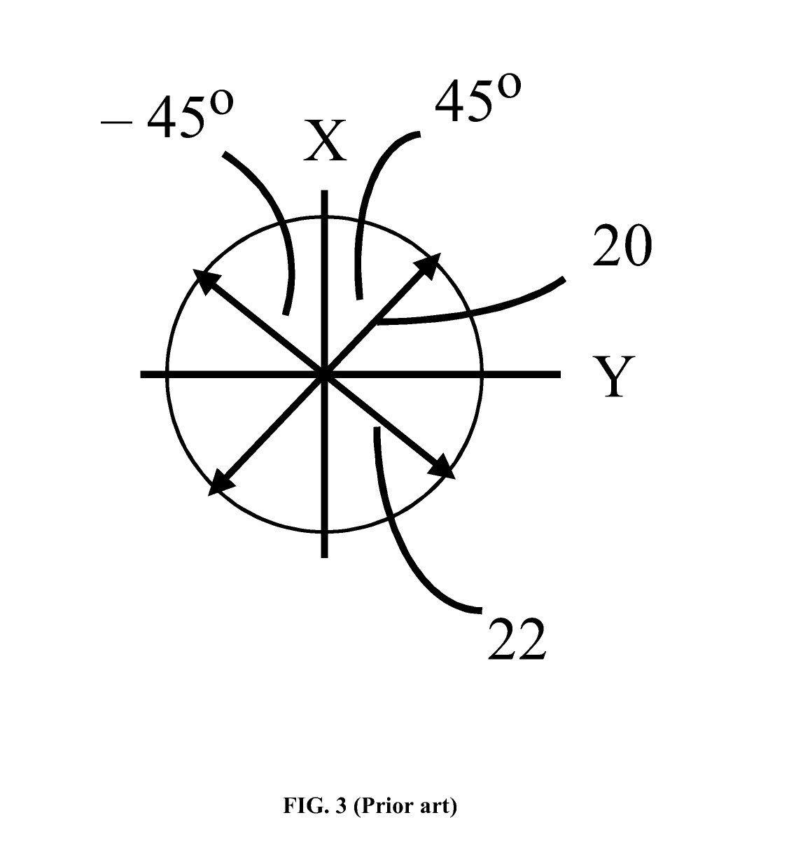

FIG. 4 shows a backward propagation light path in the isolator shown in FIG. 1;

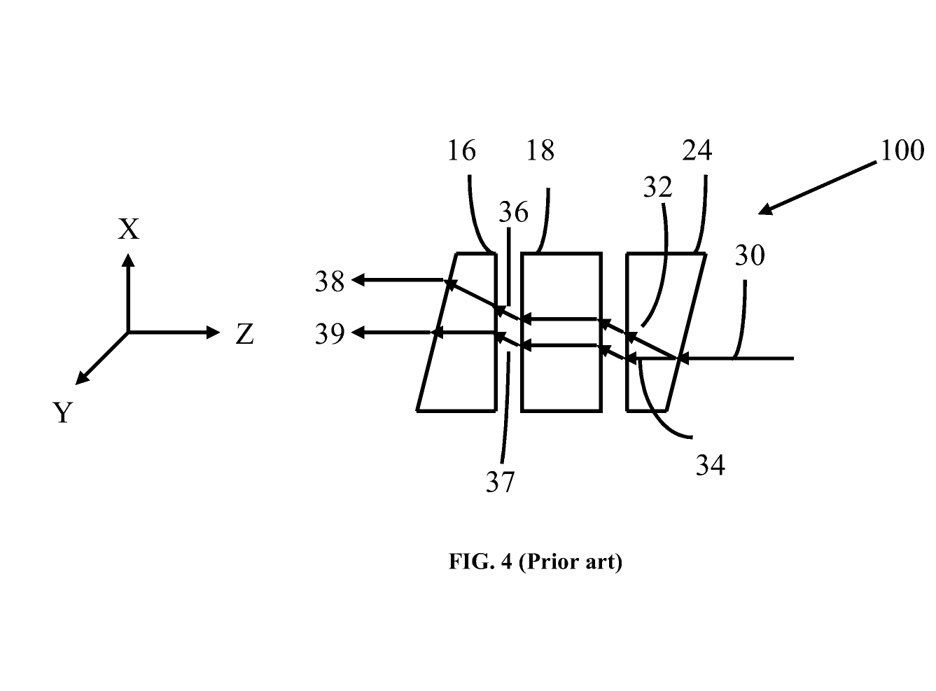

FIG. 5 illustrates a polarization plane orientation of two backward propagating lights after passing through a second birefringent crystal wedge of the isolator shown in FIG. 1;

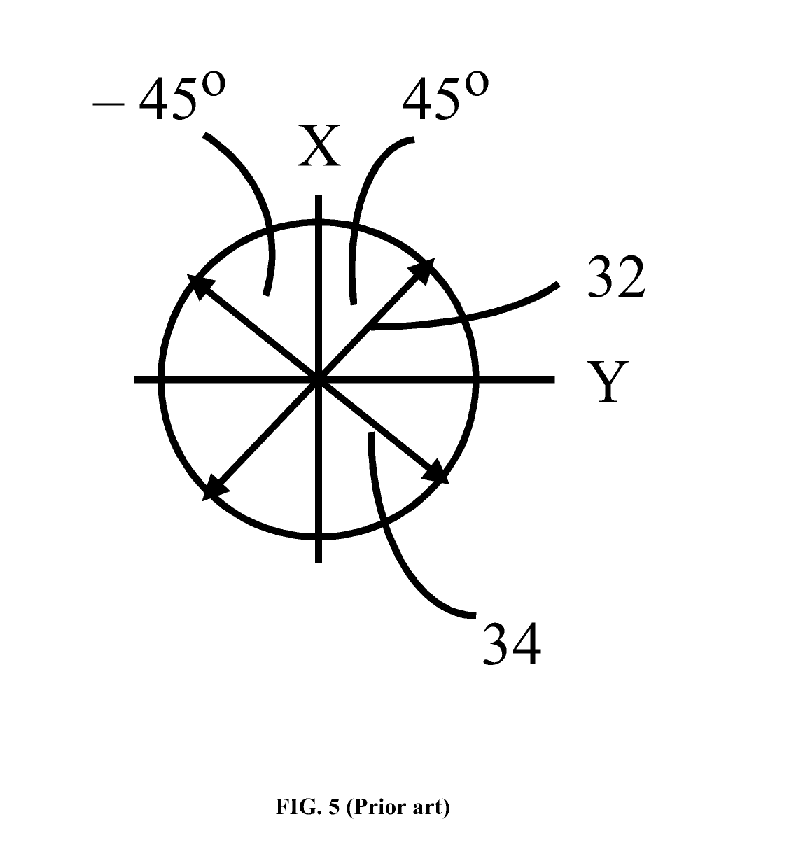

FIG. 6 illustrates a polarization plane orientation of two backward propagating lights after passing through a Faraday rotator of the isolator shown in FIG. 1;

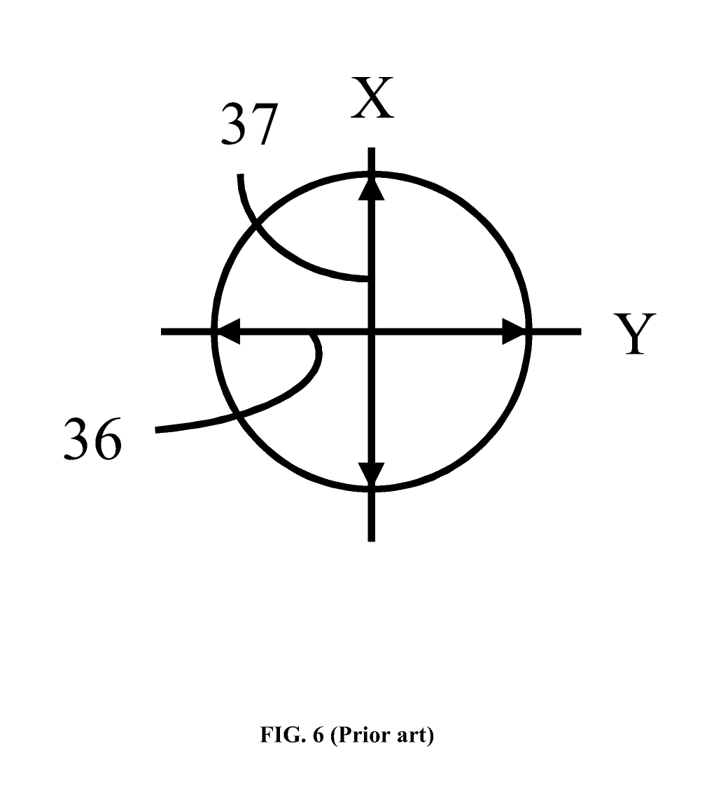

FIG. 7 shows an optical attenuator disclosed in the prior art;

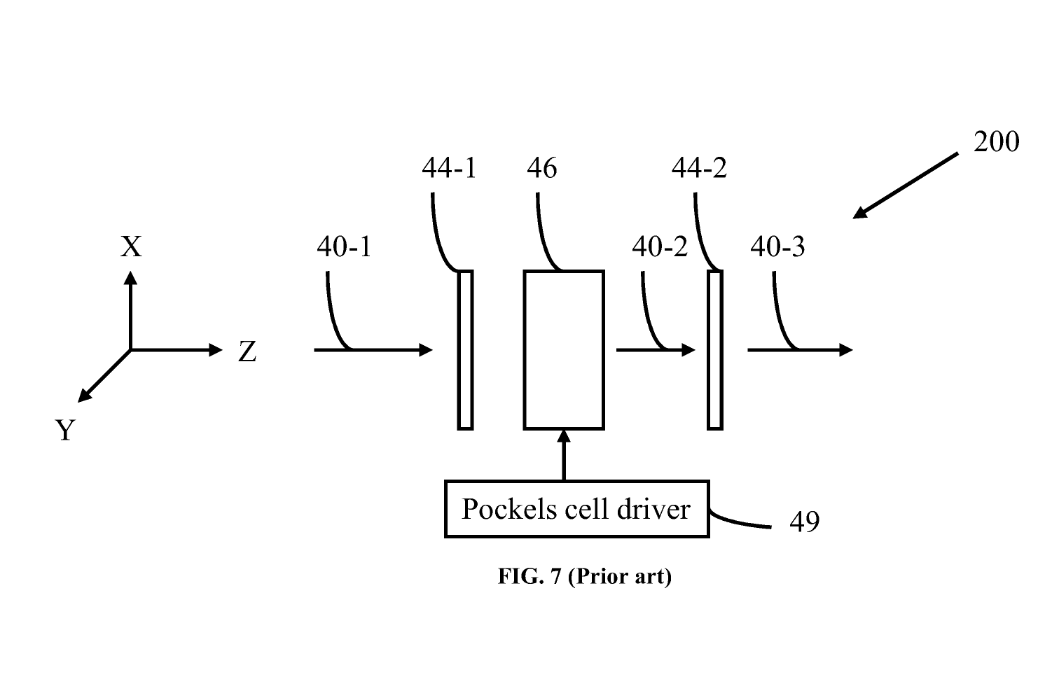

FIG. 8 shows a polarization orientation plane of a first polarizer shown in FIG. 7;

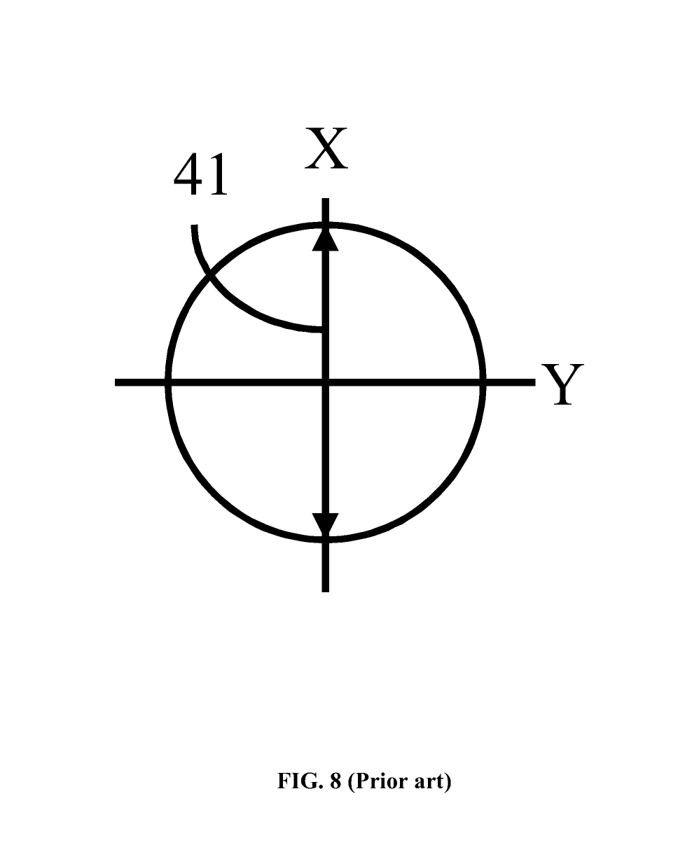

FIG. 9 shows a polarization orientation plane of a second polarizer shown in FIG. 7;

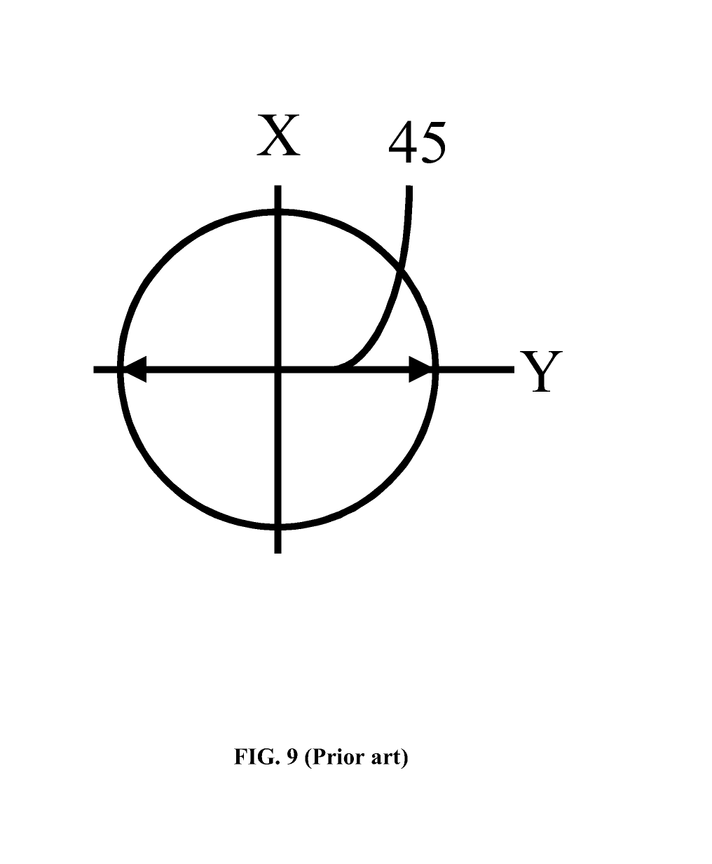

FIG. 10 shows an integrated multifunctional optical device in accordance with one embodiment of the invention;

FIG. 11 shows a polarization orientation plane of a forward propagating light after passing through a first birefringent crystal wedge when the voltage applied to Pockels cell is zero (V=0);

FIG. 12 shows a polarization orientation plane of a forward propagating light after passing through a Faraday rotator when the voltage applied to Pockels cell is zero (V=0);

FIG. 13 shows a polarization orientation plane of a forward propagating light after passing through a Pockels cell when the voltage applied to Pockels cell is zero (V=0);

FIG. 14 shows an optical path of a forward propagating light after passing through a Pockels cell when the voltage applied to Pockels cell equals to half wave volts (V=V π);

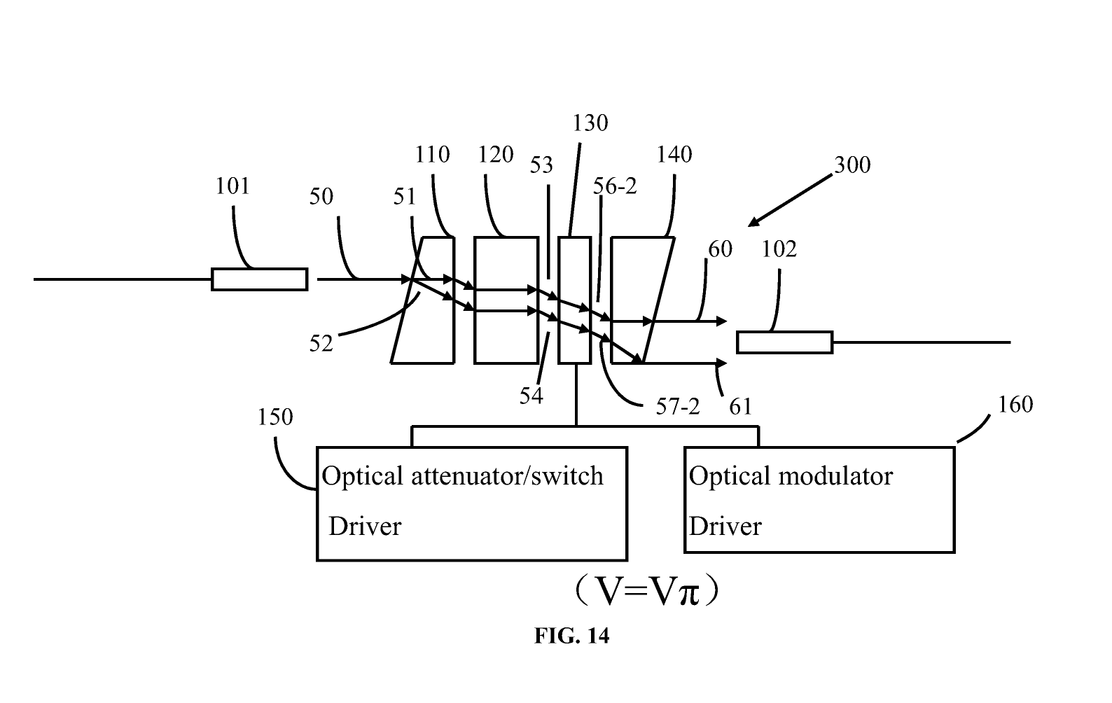

FIG. 15 shows a direction of a birefringent axes of a Pockels cell when the external voltage is applied; and

FIG. 16 shows a polarization orientation plane of a forward propagating light after passing through a Pockels cell when the voltage applied to a Pockels cell equals to half wave volts (V=Vπ).

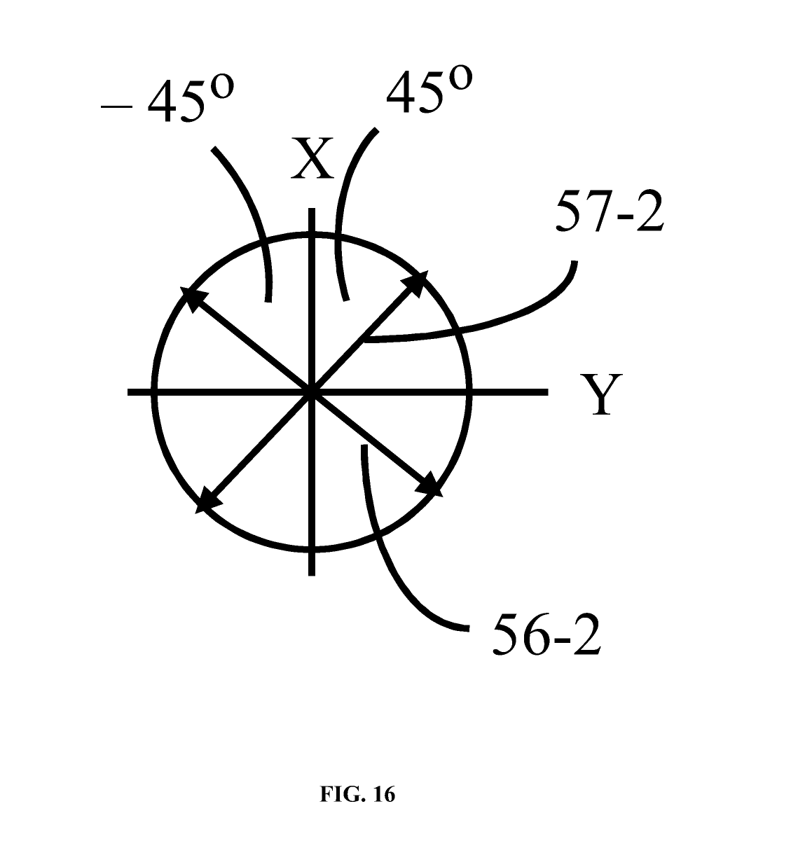

### DETAILED DESCRIPTION OF THE EMBODIMENTS

Further detailed description is made below to the embodiments of the invention with reference to the drawings.

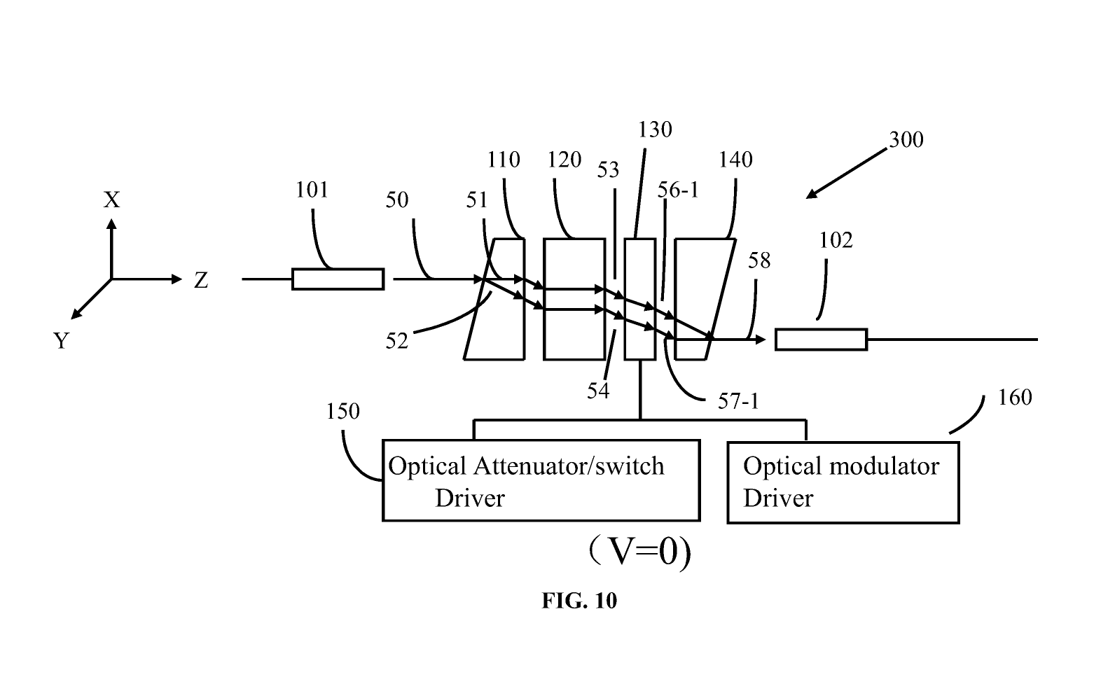

In a preferred embodiment, the configuration of an integrated polarization independent optical isolator, optical switch, variable optical attenuator, and modulator is schematically shown in FIG. 10 as an optical device 300. For easy understanding of description, the axes of coordinates are set as follows. Let a z direction (toward the right in the drawing) indicate the direction in which optical components are aligned and an x direction (vertical direction) and a y direction (horizontal direction) indicate two orthogonal directions. Forward propagating means light propagates in z direction, and backward propagating means light propagates in -z direction.

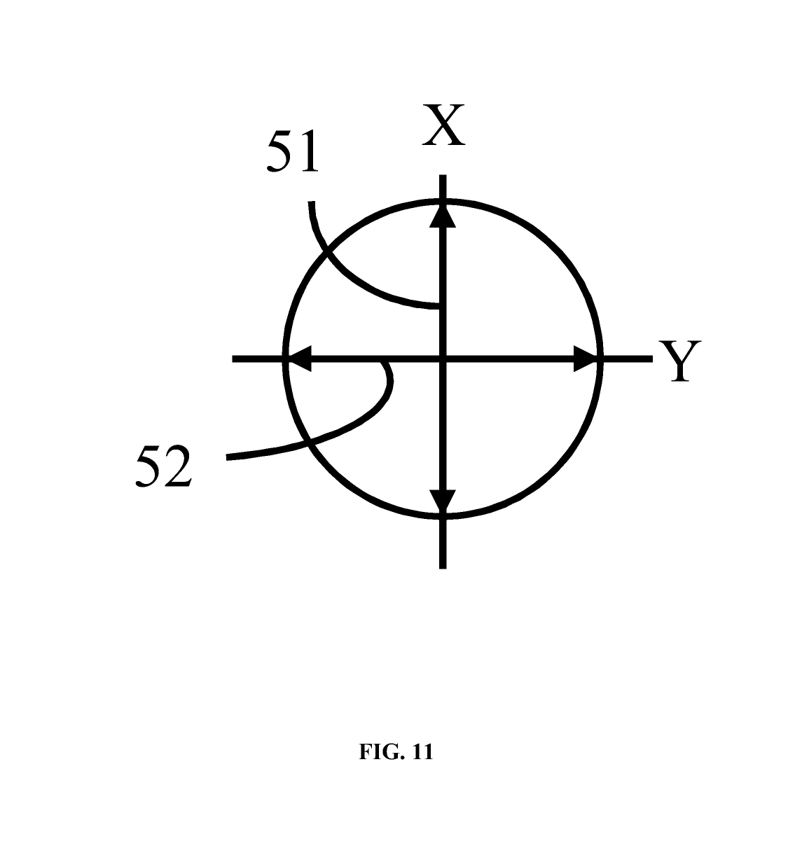

The optical device 300 comprises an input port collimator with a pigtailed single mode optical fiber 101; a first birefrigent crystal wage 110 with the o-light axis and e-light axis aligned on x-axis and y-axis respectively as shown in FIG. 11; a Faraday rotator 120; a Pockels cell 130 with the o-light and e-light axes aligned with the o-light and e-light optical axes of the first birefrigent crystal wedge 110 respectively; a second birefrigent crystal wedge 140 with optical axes aligned at 45 degree angle relative to the ordinary lights; and at −45 degree angle relative to the extraordinary lights; an output port collimator with pigtailed single mode optical fiber 102; one electric driver for variable optical attenuator and optical switch 150 and an electric driver 160 for optical modulator.

The Faraday rotator is disposed between the first birefringent crystal wedge and the Pockels cell and receives linearly polarized lights from the crystal wedge. The Pockels cell is disposed between Faraday rotator and the second birefringent crystal wedge and rotates the polarization plane of the received lights. The first birefringent crystal wedge is disposed between the input port collimator and the Faraday rotator and receives lights from the collimator. The output birefringent crystal is disposed between the Pockels cell and the output port collimator and receives lights from the Pockels cell and combines the two linearly polarized lights into a single light beam which is coupled to the output port collimator.

The first birefringent crystal wedge 110 and the second birefringent crystal wedge 140 are usually cut by 7 degrees for creating sufficient space between the two split lights, single mode fibers are used for the input and output port collimator 101 and 102. Faraday rotator 120 is designed to work for the designated wavelength of the inputted lights because the rotational angle of the polarization plane depends on the optical wavelength. Usually, the Faraday rotator is design for a single wavelength or a wavelength with certain bandwidth. The Faraday rotator used for optical telecommunication is usually made of a synthetic garnet material called Yttrium iron garnet (YIG) inside a magnetic ring. The birefringent crystal is usually made of the yttrium orthovanadate (YVO₄) and LiNbO₃. The crystals for making Pockels cell can be selected from a group of the materials such as KDP, BBO, and LiNbO₃, etc. depending on the operating optical wavelength. The following factors should be considered when select the material for Pockels cell: cost, half wave voltage, optical power damage threshold and some other factors. A Gradient Index (GRIN) lens or C-lens is usually used for making optical collimator. The input light is a coherent, monochromatic, or has limited optical spectral bandwidth.

The forward propagating light 50 outputted from the input port collimator 101 is split by the first birefringent crystal wedge 110 into the vertical component 51(o-light) and horizontal component 52 (e-light) as shown in FIG. 11. The polarization plane of the o-light and e-light are rotated 45 degrees by Faraday rotator 120 on the x-y plan. This transfer process can be expressed by the Jones Matrix:

$$1 / 2 [ \begin{matrix}1 & 1 \\ 1 & 1\end{matrix} ] .$$

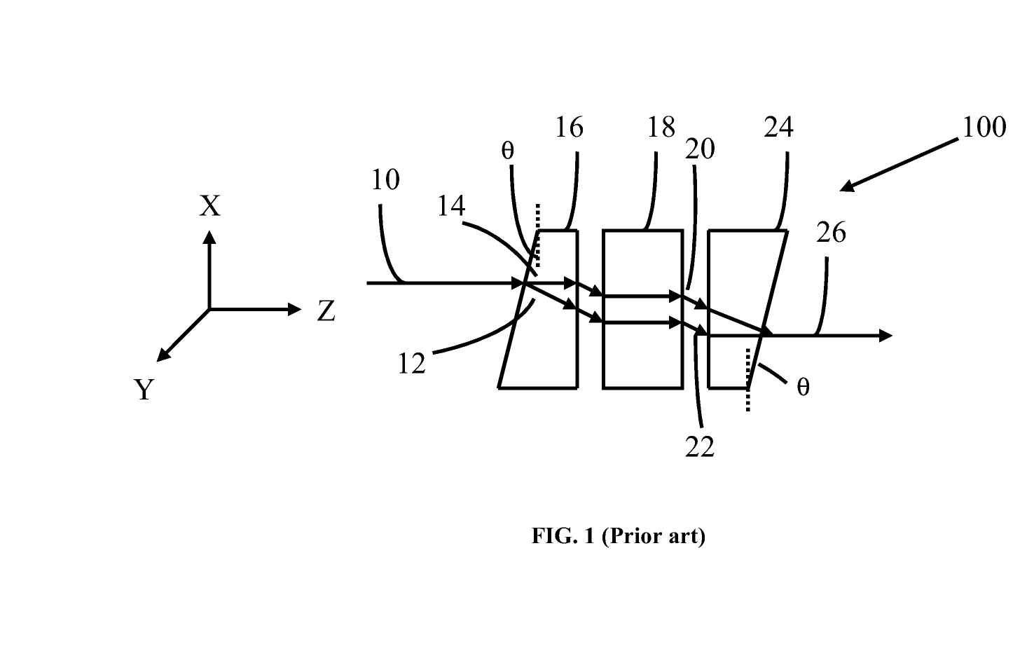

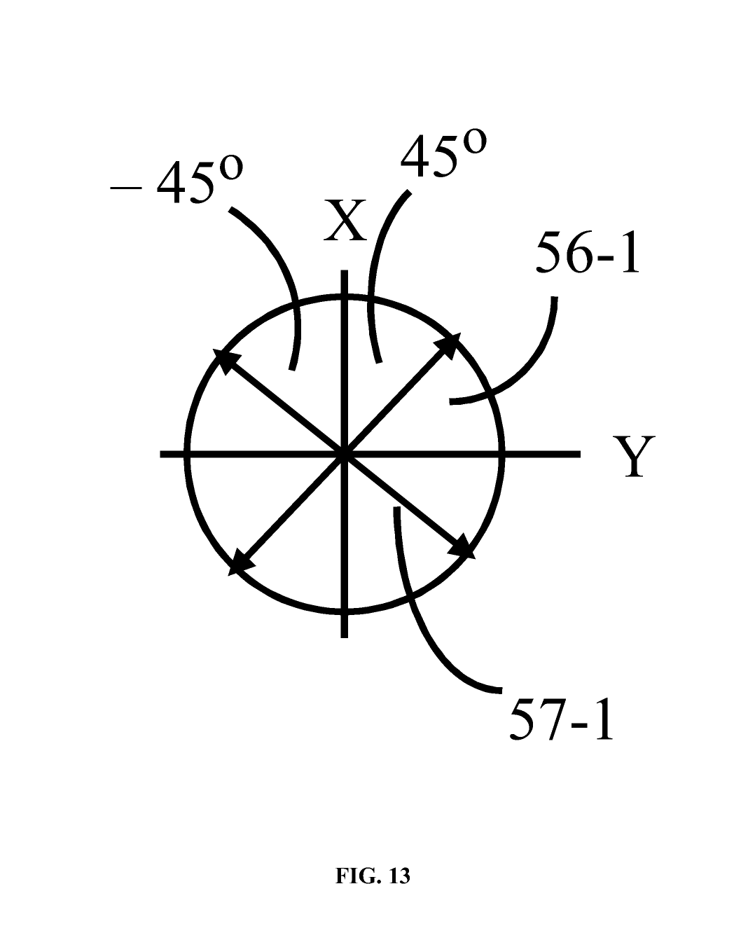

The light 53 is now at 45 degree angle and light 54 is not at −45 degrees angle to the x-axis as shown in FIG. 13. The Pockels cell 130 is a transparent isotropic (non-birefrigent) material without applied electric voltage, which means that light 53 and 54 do not change the polarization state when pass through the Pockels cell 130 when the applied voltage is zero. Lights 56 and 57 are then combined by the second birefringent crystal wedge 140 into single light 58, which is coupled to the output port collimator 102. The optical device 300 in FIG. 10 works the same way as device 100 in FIG. 1 as a polarization independent isolator providing high isolation for the backward propagating light.

When the electric voltage is applied by driver 150 and/or 160, the Pockels cell 130 becomes a voltage controlled wave plate, i.e.

$${e}^{i θ ( V )} [ \begin{matrix}1 & 0 \\ 0 & \pm i\end{matrix} ] ,$$

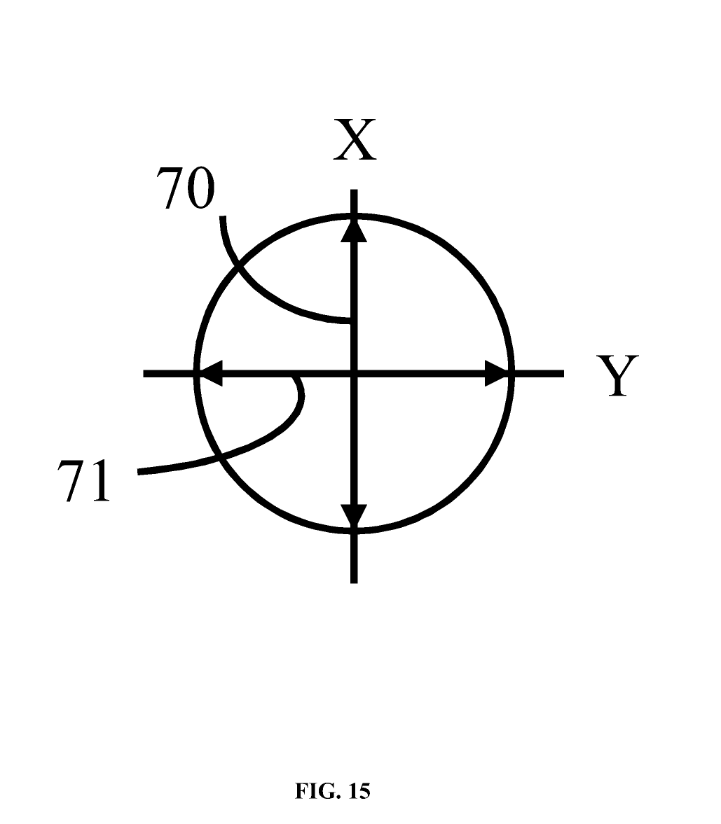

with two optical axes (o-light axis 70 and e-light axis 71) aligned with x and y axis respectively, as shown in FIG. 15. In order for the system to work as a switch, the driver 150 needs to provide a voltage high enough to drive Pockels cell as a half wave plate, i.e.

$${e}^{i θ ( V )} [ \begin{matrix}1 & 0 \\ 0 & \pm i\end{matrix} ] where θ ( V ) = \frac{π}{2} ,$$

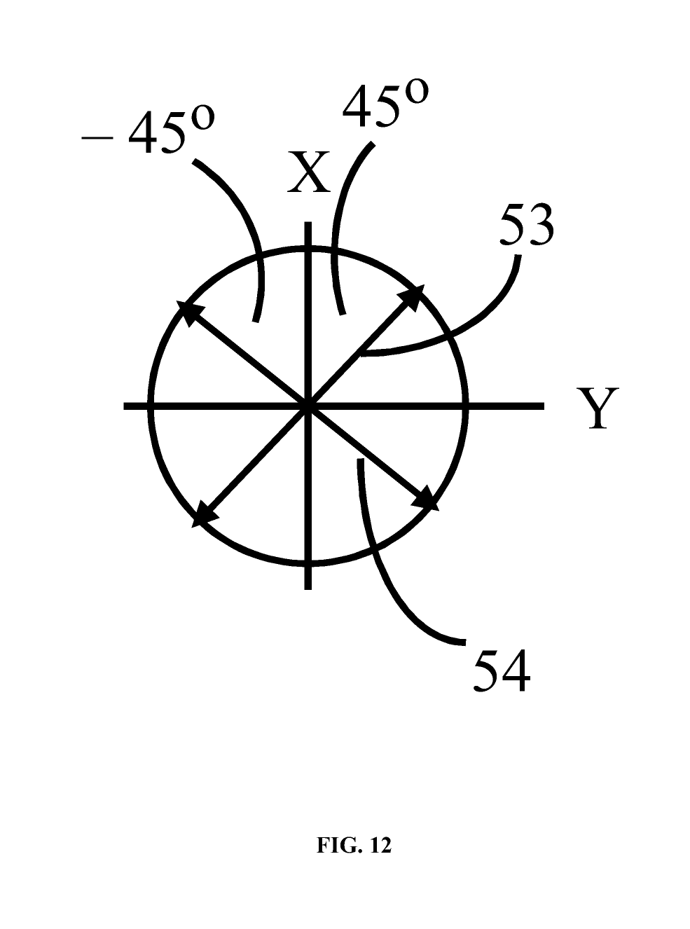

which means that the polarization plane of the input light 53 and 54 from the Faraday rotator 120 is rotated by 90 degrees by Pockels cell 130 as shown in FIGS. 12 and 13. Such a voltage is called half wave voltage (Vπ). Light 56-1 and 57-1 outputted from the Pockels cell 130 becomes e-light and o-light relative to its optical axes of the second birefringent crystal 140, and therefore, cannot be combined by the second birefringent crystal wedge 140 into one light, and therefore cannot be coupled into the output port collimator 102. Thus, the role of an optical switch is achieved.

When the voltage applied to the Pockels cell 130 varies from 0 to Vπ, the light from the input port collimator 101 coupled to the output port collimator 102 can change from near 100% pass (or near zero optical loss) to completely off (or near 100% optical loss). In practical applications, the optical device 300 without voltage applied to the Pockels cell 130 will still have some optical insertion loss due to material absorption, scattering, reflection and misalignment of the optical axes of the birefringent optical components, etc. It is worth noting that the isolation for backward propagating lights provided by the optical device 300 decreases when the voltage is applied to the Pockels cell 130. However, the optical power of the back reflected light also decreases due to the higher insertion suffered by forward propagating light. Therefore, the overall back reflected lights isolated by the optical device 300 are not compromised. Obviously, if the Pockels cell 130 is driven by modulator driver 160, the optical device 300 can modulate the inputted light 50. Due to the high half wave voltage, the modulation frequency is usually not very high. As such, a small optical amplitude modulation can be more easily achieved with low driving voltage.

The input port collimator, the first birefrigent crystal wage, the Faraday rotator, the Pockels cell, the second birefrigent crystal wedge, and the output port collimator all have antireflection coating by dielectric thin film on the optical path surfaces to reduce the reflection and insertion losses. The first birefrigent crystal wage, the Faraday rotator, the Pockels cell and the second birefrigent crystal wedge can be glued together by certain epoxy or adhesive which is transparent to the designated optical wavelength, or can be glued together with optical path epoxy free method (a method is often used in optical industries to glue optical components together but leaves optical path with no epoxy).

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An integrated multifunctional optical device, comprising:
a) an input port collimator with a pigtailed single mode optical fiber and an output port collimator with a pigtailed single mode optical fiber, the input port collimator receiving input lights, the output port collimator providing output lights;
b) a first birefrigent crystal wedge and a second birefrigent crystal wedge; the first birefrigent crystal wedge receiving the input lights from the input port collimator and splitting into two linearly polarized lights with ordinary lights in a vertical direction and extraordinary lights in a horizontal direction, the second birefrigent crystal wedge with optical axes aligned at 45 degree angle relative to the ordinary lights, and at −45 degree angle relative to the extraordinary lights;
c) a Pockels cell rotating a polarization plane of the input lights by an external electric voltage, two optical axes of the Pockels cell being aligned with two optical axes of the first birefrigent crystal wedge;
d) a Faraday rotator disposed between the first birefrigent crystal wedge and the Pockels cell, receiving lights from the first birefrigent crystal wedge; the Pockels cell disposed between the Faraday rotator and the second birefrigent crystal wedge, receiving the lights from the Faraday rotator, the second birefrigent crystal wage disposed between the Pockels cell and the output port collimator, receiving two linearly polarized lights from the Pockels cell, combining the linearly polarized lights into one light and outputting to the output collimator;
e) at least one electric driver for a variable optical attenuator and an optical switch; and
f) an electric driver for an optical modulator.

2. The integrated multifunctional optical device of claim 1, wherein the input lights to the input port collimator are coherent, monochromatic or the lights with limited optical spectral bandwidth.

3. The integrated multifunctional optical device of claim 1, wherein the Faraday rotator is set to rotate the polarization plane of the linearly polarized lights by 45 degree angle for a single wavelength or for lights with limited spectral bandwidth.

4. The integrated multifunctional optical device of claim 1, wherein the Faraday rotator is selected based on the wavelength of the input lights.

5. The integrated multifunctional optical device of claim 1, wherein the electric field applied to the Pockels cell is parallel or perpendicular to a propagation direction of the input lights.

6. The integrated multifunctional optical device of claim 1, wherein the Pockels cell is selected based on the wavelength of the input lights.

7. The integrated multifunctional optical device of claim 1, wherein antireflection dielectric thin film coatings are applied to optical path surfaces of the input port collimator, the first birefrigent crystal wage, the Faraday rotator, the Pockels cell, the second birefrigent crystal wage, the output port collimator to reduce the reflection and optical insertion loss.

8. The integrated multifunctional optical device of claim 1, wherein the first birefrigent crystal wage, the Faraday rotator, the Pockels cell, and the second birefrigent crystal wage is glued together by an epoxy which is transparent to the input lights, or glued together with an optical path epoxy free method.
